(19) United States
(12) Patent Application Publication
(10) Pub. No.: US 2003/0051900 A1
(43) Pub. Date: Mar. 20, 2003

(54) Electrical wire insulation

(76) Inventors: Giles Henry Rodway, Calne Wiltshire (GB); Joseph Charles Read, Wiltshire (GB); Liam McKeough, Wiltshire (GB)

Correspondence Address: Tyco Electronics Corporation, Intellectual Property Law Department, 307 Constitution Drive, MS R20 2B, Menlo Park, CA, 94025-1164, US

(21) Appl. No.: 10/239,687

(22) PCT Filed: Mar. 16, 2001
(86) PCT No.: PCT/GB01/01143

(30) Foreign Application Priority Data
Mar. 16, 2000 (GB) 0006333.9

(51) Int. Cl. H01B 7/00

(52) U.S. Cl. 174/120 R

(57) ABSTRACT

An electrical wire or cable having insulation comprising

(I) at least a first layer of a polyolefin-based formulation, of which at least 20%, preferably at least 40%, more preferably at least 60% or very preferably at least 80% of the weight of the polymeric portion of the said formulation consists of a carbonyl-containing polymer (homopolymer or copolymer or terpolymer), of which polymer the or at least one constituent monomer is a carboxylic acid ester, preferably an acrylate or acetate, especially an alkyl acrylate (preferably methyl acrylate, ethyl acrylate, propyl acrylate or butyl acrylate), the said monomer itself constituting at least 5%, preferably at least 9%, more preferably at least 15% by weight of the said co-, or ter- polymer when used, and the remainder or the majority of the remainder of the said co-, or ter- polymer preferably being derived from olefinic monomer, preferably ethylene; in contact with

(II) at least a second layer of another material formulation, containing at least 10%, more preferably at least 50%, very preferably at least 90%, especially 100%, by weight of the second layer, of non-PVDF-based fluoropolymer, preferably based on ETFE or ECTFE;

wherein the said layers (T) and (II) whilst in contact with each other have been subjected to cross-linking reaction, preferably by radiation, more preferably ionising radiation, sufficient to create a significant bond between the two layers, or to increase the peel bond strength between the said layers to at least 3N, preferably increasing the bond strength by at least 50%, more preferably by at least 100%, especially by at least 500% or 1000%, compared to that between the layers prior to the cross-linking reaction.

This invention relates to insulation for electrical wire or cable (hereinafter “wire”) and is especially useful in multi-layer insulation of electrical wires

The following abbreviations will be used hereinafter:

PJ=Primary jacket; pro-rad=crosslinking promoter; TMPTM=trimethylolpropanetrimethacrylate; TAC=triallylcyanurate; TAIC=triallylisocyanurate; ASTM=American Society for Testing and Materials; PVDF=polyvinylidene fluoride; ETFE=ethlyene/tetrafluoroethylene; ECTFE=ethylene/chlorotrifluoroethylene; HDPE=high density polyethylene; EEA=ethylene/ethyl acrylate; EA=ethyl acrylate; MFR=melt flow rate.

Wires with chemically-resistant dual-wall insulation comprising a polyolefin inner layer (core) and a fluoropolymer outer layer (primary jacket or PJ) have been commercially available for over 30 years, and are available from several different manufacturers. Dual wall wires which possess negligible bonding between these two insulation layers consequently suffer from a number of performance shortcomings, including a tendency to wrinkling, crack propagation, and peeling of the outer insulation layer. The tendency of polyolefin and fluoropolymer insulation layers not to bond appears to be at least partly due to the relatively high degree of chemical inertness of fluoropolymers. Indeed, in some cases, e.g. ethylene tetrafluoroethylene (ETFE), fluoropolymers are amongst the most chemically inert polymers known.

It has now been surprisingly discovered, according to the present invention, that the dissimilar insulation materials of a core based on a polyolefin and a PJ based on a fluoropolymer that is selected from a group of fluoropolymers which are hereinafter described as non-PVDF-based fluoropolymers (which term includes fully and (preferably) partially fluorinated fluoro-homopolymers and fluoro-copolymers and fluoro-terpolymers other than PVDF homopolymers or PVDF-based copolymers) can be bonded together to a significant level of adhesion on an electrical wire or cable, and that this bonding tends to reduce or eliminate outer insulation cracking on a wire and affords improvements in other performance characteristics mentioned above. Significant bond strength is unexpectedly achieved by a combination of a selected formulation of a polyolefin-based layer, in contact with a non-PVDF-based fluoropolymer-based layer, and a cross-linking reaction, preferably effected by the application of radiation, especially ionising radiation.

The invention accordingly provides an electrical wire having insulation comprising:

(I) at least a first layer of a polyolefin-based material comprising at least 20%, preferably at least 40%, more preferably at least 60% or at least 80%, by weight (of the whole material composition) of a carbonyl-containing polymer (homopolymer or copolymer or terpolymer) having a non-aromatic backbone, of which polymer the or at least one constituent monomer is a carboxylic acid ester, preferably an acrylate or acetate, especially an alkyl acrylate (preferably methyl acrylate, ethyl acrylate, propyl acrylate or butyl acrylate), the said monomer itself constituting at least 5%, preferably at least 9%, more preferably at least 15% by weight of the said co-, or ter- polymer when used, and the remainder of the said co-, or ter-polymer preferably being derived from olefinic monomer, preferably ethylene; in contact with;

(II) at least a second layer of a material containing at least 10%, more preferably at least 50%, or at least 90%, by weight based on the whole material composition, of a non-PVDF-based fluoropolymer or a mixture of such fluoropolymers, preferably a partially fluorinated non-PVDF-based fluoropolymer, preferably based on ETFE or on ECTFE;

wherein the said layers (I) and (II) whilst in contact with each other have been subjected to cross-linking reaction, preferably by radiation, more preferably ionising radiation, the cross-linking preferably being sufficient to increase the peel bond strength between the said layers to at least 3N (according to ASTM 1876-95), preferably increasing the bond strength by at least 50%, more preferably by at least 100%, especially by at least 500% or 1000%, compared to that between the layers prior to the crosslinking reaction.

Another aspect of the invention provides an electrical wire having insulation comprising:

(I) at least a first layer of a polyolefin-based formulation, of which at least 20%, preferably at least 40%, more preferably at least 60% or very preferably at least 80% of the weight of the polymeric portion of the said formulation consists of a carbonyl-containing polymer (homopolymer or copolymer or terpolymer), of which polymer the or at least one constituent monomer is a carboxylic acid ester, preferably an acrylate or acetate, especially an alkyl acrylate (preferably methyl acrylate, ethyl acrylate, propyl acrylate or butyl acrylate), the said monomer itself constituting at least 5%, preferably at least 9%, more preferably at least 15% by weight of the said co-, or ter- polymer when used, and the remainder or the majority of the remainder of the said co-, or ter- polymer preferably being derived from olefinic monomer, preferably ethylene; in contact with

(II) at least a second layer of a material containing at least 10%, more preferably at least 50%, or at least 90%, by weight based on the whole material composition, of a non-PVDF-based fluoropolymer or a mixture of such fluoropolymers, preferably a partially fluorinated non-PVDF-based fluoropolymer, preferably based on ETFE or on ECTFE or terpolymers based on ETFE or ECTFE with partially or fully fluorinated comonomers;

wherein the said layers (I) and (II) whilst in contact with each other have been subjected to cross-linking reaction, preferably by radiation, more preferably ionising radiation, the cross-linking preferably being sufficient to prevent delamination of the two layers during subsequent handling operations e.g. wrapping the wire round a mandrel of diameter equal to twice that of the insulated wire or to increase the peel bond strength between the said layers to at least 3N according to the ASTM B1876-95 method described below preferably increasing the bond strength by at least 50%, more preferably by at least 100%, especially by at least 500% or 1000%, compared to that between the layers prior to the cross-linking reaction.

Another aspect of the invention provides an electrical wire having insulation comprising:

(I) at least a first layer of a polyolefin-based formulation, of which at least 20%, preferably at least 40%, more preferably at least 60% or very preferably at least 80% of the weight of the polymeric portion of the said formulation consists of a carbonyl-containing polymer (homopolymer or copolymer or terpolymer), of which polymer the or at least one constituent monomer is a carboxylic acid ester, preferably an acrylate or acetate, especially an alkyl acrylate (preferably methyl acrylate, ethyl acrylate, propyl acrylate or butyl acrylate), the said monomer itself constituting at least 5%, preferably at least 9%, more preferably at least 15% by weight of the said co-, or ter- polymer when used, and the remainder or the majority of the remainder of the said co-, or ter- polymer preferably being derived from olefinic monomer, preferably ethylene; in contact with

(II) at least a second layer of another material formulation, containing at least 10%, more preferably at least 50%, very preferably at least 90%, especially 100%, by weight of the second layer, of a non-PVDF-based ter-fluoropolymer, or a mixture of non-PVDF-based fluoropolymers containing one or more non-PVDF-based ter-fluoropolymers, preferably a partially fluorinated ter-fluoropolymer, more preferably terpolymers based on tetrafluoroethylene and hexafluoropropylene with fully or preferably partially or non-fluorinated comonomers such as ethylene or vinylidene fluoride, provided that the vinylidene fluoride comonomer does not constitute greater than 50wt % of the copolymer;

wherein the said layers (I) and (II) whilst in contact with each other have been subjected to cross-linking reaction, preferably by radiation, more preferably ionising radiation, the cross-linking preferably being sufficient to prevent delamination of the two layers during subsequent handling operations e.g. wrapping the wire round a mandrel of diameter equal to twice that of the insulated wire or to increase the peel bond strength between the said layers to at least 3N according to the ASTM B1876-95 method described below preferably increasing the bond strength by at least 50%, more preferably by at least 100%, especially by at least 500% or 1000%, compared to that between the layers prior to the cross-linking reaction.

Preferably, the respective layers have been brought into contact with each other at a temperature above the melting or softening point of the polymeric material in at least one of the layers, thus tending to maximise the intimacy of their interfacial contact and so possibly encouraging the formation of adhesion-promoting interfacial cross-links in the subsequent cross-linking reaction.

The polyolefin-based layer (I) in addition to the polymeric portion of the formulation, for which the requirements are stipulated above, may contain whatever else is required in the way of additives such as anti-oxidants, pigments, fillers, flame retardants, etc, as known per se, to give the required mechanical, thermal, electrical etc. properties to the polymer.

The fluoropolymer-based layer (II) also may contain mixtures of two or more non-PVDF-based fluoropolymers and may contain other additives as known per se to give it required properties in addition to bonding.

Advantages of achieving a strong bond in accordance with this invention include:

abrasion resistance of surface layer, and the insulation as a whole can increase if it (the surface layer) is bonded to a substrate material;

improved resistance to peel, especially if one of the layers is damaged/perforated;

improved resistance to blistering of the two layers, if heat is applied;

improved resistance to delamination/creasing/wrinkling between the two layers, e.g. due to mechanical stress or chemical exposure e.g. to solvents.

achievement of reduced wire bend wrinkling and improvement in the above characteristics, while maintaining adequate cut-through and notch propagation resistance, the latter being unexpected since strongly adherent layers would normally be expected fairly easily to transmit a cut or notch in the outer layer through to the inner layer.

The bond strength described in this application can be measured in terms of peel strength between bonded strips of the two materials in question. A standard method which can be used for such a test is ASTM 1876-95. By this definition, a moderate bond might have a peel force of >3N, a significant bond could be one for which the peel force exceeds 5N, and a strong bond one of peel force greater than 10N. A convenient method for gauging the bond strength between the said layers is to slit the insulation along the wire axis for 50 mm, to the depth of the conductor, and to then wrap the wire round a mandrel, of diameter equal to twice the wire diameter, with the slit on the outside of the bend, so as to expose the conductor, and to then unwrap the wire from the mandrel until the wire is straight. If the inner and outer insulation layers have not spontaneously separated by this process there is at least a moderate bond between the layers.

Methods of fabricating the wire may include any process which causes intimate contact between the above-mentioned layers (i) and (ii). Examples, include coating of one material onto a pre-formed layer of the other, dual or multi-walled extrusion to form insulation layers respectively containing one or other of the aforementioned two classes of material. The olefin-based material (i) is preferably the inner layer and the fluoropolymer-based layer (ii) preferably the outer layer on the wire. The layers made from the two different materials could be coextruded, tandem extruded, multipass extruded, or coated by other means. Known wire insulation processes such as tube draw-down extrusion may be used, to form one or more of the layers, but pressure extrusion as known per se is preferred for optimum adhesion of the second and any subsequent insulation layers to be applied to a pre-formed underlying layer.

The insulation on the wire is exposed to a cross-linking reaction, which may involve chemical reagents such as peroxides, but preferably is effected by radiation, especially from a source of ionising radiation capable of causing the formation of free radicals and thus, cross-links, in the polymers, some of which should preferably be formed in the region of the interface between the two materials. Penetration of the radiation into the material at least as far as the interface is therefore desirable, although not necessarily essential if ion or radical mobility, for example, enables molecular reactions to continue at or near the interface after the radiation process. The radiation source could, for example, be a radio-isotope, or an X-ray source, or possibly a non-ionising radical-generating source, for example a UV source, but is preferably an electron beam, more preferably one providing a beam dose greater than 2 Mrads, preferably at least 5 Mrads, more preferably at least 10 Mrads, very preferably at least 15 Mrads, into the material.

It has been found that enhancements to the interfacial bond strength may be obtained by using certain additives. Additives preferably include a cross-linking promoter (“pro-rad”) in the polyolefin-based material and/or in the fluoropolymer-based material. Known cross-linking materials may be used, preferably methacrylate/acrylate based ones, and, very preferably, those of the type trimethylolpropanetrimethacrylate (TMPTM) in the polyolefin material and/or in the fluoropolymer-based material. Additionally, crosslinking promoters of the multifunctional allyl type, preferably triallyl cyanurate (TAC), more preferably triallyl isocyanurate (TAIC), in the polyolefin material and preferably in the fluoropolymer-based material, may be used.

Experimental results:

All results quoted in the tables below were obtained by testing pressed plaques of the two materials prepared by the usual polymer handling techniques, well known per se. The plaques were pressed together to adhere them temporarily face-to-face and the adhering plaques were then irradiated as indicated. Plaques were used to represent the layers I and II for these demonstration experiments, due to the relative ease of measuring bond strength on plaques, rather than on wires. Conditions for these experiments were as follows:

Plaque dimensions: 150 mm by 150 mm by 0.85 mm Pressing temperature: 220° C.

Pressing time: 2 minute preheat, 1 minute at pressure

Pressing pressure: 20-40 Tons between 300 mm by 300 mm metal plates

Cooling conditions: 2 minutes at same pressure with same plates water cooled.

| | | | |
|---|---|---|---|
| | | Dose | Mean maximum |
| Material 1 | Material 2 | (Mrads) | peel force (N) |

Example of Effect of Radiation Dose on Bond strength developed
between appropriate polyolefin and fluoropolymer-based materials

| | | | |
|---|---|---|---|
| EEA copolymer of | ETFE of MFR* = 33 | 0 | 0.5 |
| 15 wt % EA content | | | |
| EEA copolymer of | ETFE of MFR* = 33 | 20 | 9 |
| 15 wt % EA content | | | |
| EMA copolymer of | ETFE of MFR* = 33 | 0 | 0.8 |
| 28 wt % MA | | | |
| content | | | |
| EMA copolymer of | ETFE of MFR* = 33 | 20 | 5 |
| 28 wt % MA | | | |
| content | | | |
| EEA copolymer of | ETFE of MFR* = | 0 | 0.5 |
| 15 wt % EA content | 5.5 + 5 wt % TAC | | |
| EEA copolymer of | ETFE of MFR* = | 20 | 17.5 |
| 15 wt % EA content | 5.5 + 5 wt % TAC | | |
| EEA copolymer of | ECTFE of MFR** = | 0 | 1.5 |
| 15 wt % EA content | 11 | | |
| EEA copolymer of | ECTFE of MFR** = | 20 | 28 |
| 15 wt % EA content | 11 | | |
| EEA copolymer of | Terpolymer of tetra- | 0 | 1.8 |
| 15 wt % EA content | fluoroethylene, hexa- | | |
| | fluoropropylene & | | |
| | vinylidene fluoride of | | |
| | MFR** = 13 | | |
| EEA copolymer of | Terpolymer of tetra- | 20 | 36 |
| 15 wt % EA content | fluoroethylene, hexa- | | |
| | fluoropropylene & | | |
| | vinylidene fluoride of | | |
| | MFR** = 13 | | |
| EEA copolymer of | Terpolymer of hexa- | 0 | 2.4 |
| 15 wt % EA content | fluoropropylene, tetra- | | |
| | fluoroethylene & | | |
| | ethylene of MFR** = | | |
| | 6.7 | | |
| EEA copolymer of | Terpolymer of hexa- | 20 | 13 |
| 15 wt % EA content | fluoropropylene, tetra- | | |
| | fluoroethylene & | | |
| | ethylene of MFR** = | | |
| | 6.7 | | |

Example of Effect of the addition of Pro-rad in fluoropolymer-based
material on bond strength with appropriate polyolefin-based material
after electron beam crosslinking

| | | | |
|---|---|---|---|
| EEA copolymer of | ETFE of | 20 | 6.5 |
| 15 wt % EA content | MFR* = 5.5 | | |
| EEA copolymer of | ETFE of | 20 | 17.5 |
| 15 wt % EA content | MFR* = 5.5 + 5 wt % | | |
| | TAC | | |

Effect of percentage Copolymer in a polyolefin polymer blend on bond
strength with appropriate non-PVDF-based fluoropolymer-based
material after electron beam crosslinking

| | | | |
|---|---|---|---|
| 100% HDPE | ETFE of MFR* = 33 | 20 | 0 |
| 100% EEA | ETFE of MFR* = 33 | 20 | 9 |
| copolymer of | | | |
| 15 wt % EA content | | | |

The Melt Flow Rate (MFR) used to describe the fluoropolymers in the tables above is quoted in units of grammes/10 minutes and was measured according to ASTM D1238-95 under the following conditions; *297° C./5 Kg **265° C./5 Kg.

### Examples of Wire Construction

An electrical wire in which the insulation consists of two polymeric layers bonded together according to the present invention was made as follows:

The inner layer of insulation (I) (i.e. nearer to the wire conductor) was a polyolefin-based material, consisting predominantly of (a) an EEA copolymer containing 15 wt % EA and (b) HDPE in a weight ratio of approximately 8:2 copolymer:HDPE, with usual other additives present in smaller proportions including crosslinking promoters, stabilisers, antioxidants, pigments and process aids at a total level of 24 wt %. This layer was pressure extruded onto the metallic conductor.

The outer layer of insulation (TI) consisted predominantly of an ETFE copolymer, which in this example contains a crosslinking promoter at 8 wt %. This outer layer was pressure extruded in a separate operation onto the pre-formed inner layer. This coated wire product was then passed through an electron beam, and received a radiation dose of 20 Mrads.

In a second example a wire was made as above, in which the additives of the inner layer were added at a total level of 22.9 wt % and the outer layer was comprised solely of the ETFE copolymer. This coated wire product was then passed through an electron beam, and received a radiation dose of 20 Mrads.

Demonstration of improved performance of wire as in the example above, relative to a wire of similar construction in which the inner and outer insulation layers are not bonded. A wire of the above construction and manufacturing process (designated wire A) was compared with another crosslinked but non-bonded polyolefin/ETFE dual-walled wire (designated wire B) of the same dimensions, over a range of tests for wire robustness relevant to harsh handling and end use environments. The following results were obtained.

Example of resistance to insulation separation improvement

Method: wire size 0.75 mm², wire insulation slit to depth of conductor along wire axis, slit length 50mm, 4 close-pitched wraps around a 3.60 mm mandrel then unwrapped until straight, temperature 23° C.

| Wire Type | Result of insulation separation test |
|---|---|
| A | No spontaneous separation/delamination of |
| | core and PJ observed |
| B | PJ spontaneously wrinkled and separated from core |

Example of scrape abrasion resistance improvement

Method: Equipment=conventional type wire scrape abrader, wire size 0.75 mm²(conductor cross sectional area), blade type angled 90°, with 0.225 mm radiused edge contact point, applied load 0.5 Kg, stroke length 10 mm, at 55 cycles/minute, temperature 23° C.

| Wire Type | No. of scrape cycles to abrade through PJ |
|---|---|
| A | 540 |
| B | 129 |

1. An electrical wire or cable having insulation comprising
(I) at least a first layer of a polyolefin-based material comprising at least 20%, by weight (of the whole material composition) of a carbonyl-containing polymer (homopolymer or copolymer or terpolymer), of which polymer the or at least one constituent monomer is a carboxylic acid ester, preferably an acrylate or acetate, especially an alkyl acrylate (e.g. methyl acrylate, ethyl acrylate, propyl acrylate or butyl acrylate), the said monomer itself constituting at least 5% by weight of the said co-, or ter- polymer when used and the remainder of the said co-, or ter- polymer preferably being derived from olefinic monomer, preferably ethylene; in contact with
(II) at least a second layer of a material containing at least 10%, by weight based on the whole material composition, of non-PVDF-based fluoropolymer or a mixture of such fluoropolymers;
wherein the said layers (I) and (II) whilst in contact with each other have been subjected to cross-linking reaction.

2. An electrical wire or cable having insulation comprising
(I) at least a first layer of a polyolefin-based formulation, of which at least 20%, preferably at least 40%, more preferably at least 60% or very preferably at least 80% of the weight of the polymeric portion of the said formulation consists of a carbonyl-containing polymer (homopolymer or copolymer or terpolymer), of which polymer the or at least one constituent monomer is a carboxylic acid ester, preferably an acrylate or acetate, especially an alkyl acrylate (preferably methyl acrylate, ethyl acrylate, propyl acrylate or butyl acrylate), the said monomer itself constituting at least 5%, preferably at least 9%, more preferably at least 15% by weight of the said co-, or ter- polymer when used, and the remainder or the majority of the remainder of the said co-, or ter- polymer preferably being derived from olefinic monomer, preferably ethylene; in contact with
(II) at least a second layer of another material formulation, containing at least 10%, more preferably at least 50%, very preferably at least 90%, especially 100%, by weight of the second layer, of a non-PVDF-based fluoropolymer or a mixture of such fluoropolymers;
wherein the said layers (I) and (II) whilst in contact with each other have been subjected to cross-linking reaction.

3. A wire or cable according to claim 1 or 2, wherein the non-PVDF-based fluoropolymer is partially fluorinated, preferably based on ETFE or ECTFE or co- or ter-polymers of ETFE or ECTFE.

4. A wire or cable according to claim 1 or 2, wherein the non-PVDF-based fluoropolymer is a ter-polymer, preferably based on tetrafluoroethylene and/or hexafluoropropylene comonomers, preferably copolymerised with ethylene or vinylidene fluoride provided the vinylidene fluoride comonomer does not constitute greater than 50 wt % of the said terpolymer.

5. A wire or cable according to claim 1 or 2, wherein the non-PVDF-based fluoropolymer is a co-polymer, preferably based on tetrafluoroethylene or hexafluoropropylene comonomers, preferably copolymerised with ethylene or vinylidene fluoride provided the vinylidene fluoride comonomer does not constitute greater than 50 wt % of the said terpolymer.

6. A wire or cable according to any preceding claim, wherein the said layers (I) and (II) whilst in contact with each other have been subjected to the said cross-linking reaction sufficiently to increase the peel bond strength between the said layers to at least 3N according to ASTM 1876-95 (preferably as hereinbefore described).

7. A wire or cable according to any preceding claim, wherein the said layers (I) and (TI) whilst in contact with each other have been subjected to the said cross-linking reaction sufficiently to prevent delamination of the two layers on slitting of the wire along its axis, followed by wrapping and then unwrapping the wire round a mandrel of diameter equal to twice that of the insulated wire.

8. A wire or cable according to any preceding claim, wherein the cross-linking reaction has increased the bond strength by at least 50%, preferably by at least 100%, especially by at least 500% or 1000%, compared to that between the uncrosslinked layers.

9. A wire or cable according to any preceding claim, wherein the respective layers have been brought into contact with each other prior to cross-linking of either layer and at a temperature above the melting or softening point of the polymeric material in at least one of the layers.

10. A wire or cable according to any preceding claim, wherein the polyolefin-based layer comprises a mixture of polyethylene and the said carbonyl-containing polymer.

11. A wire or cable according to any preceding claim, comprising an inner layer of the said polyolefin-based material and an outer layer of the said non-PVDF-based fluoropolymer-based material.

12. A wire or cable according to claim 11, wherein the said outer layer has been pressure-extruded onto the said inner layer.

13. A wire or cable according to any preceding claim, wherein the cross-linking reaction has been effected by radiation, preferably ionising radiation.

14. A wire or cable according to any preceding claim, comprising multiple alternating layers of the materials constituting the said layers (I) and (II).

15. A wire or cable according to any preceding claim, which contains at least one crosslinking promoter in the material of either or both of the said layers (I) and (II).

16. A wire or cable according to any preceding claim, which contains at least one crosslinking promoter in the material of either or both of the said layers (I) and (II), wherein the crosslinking promoter is a multifunctional acrylate or methacrylate ester, preferably trimethylolpropanetrimethacrylate (TMPTM), or the crosslinking promoter is a multi-functional allyl compound, preferably TAC or more preferably TAIC.

17. A wire or cable according to claim 15 or 16, wherein the cross-linking promoter has been added only to the material of the said layer (I).

18. A wire or cable according to any of the preceding claims, wherein the layer (II) is substantially transparent, preferably containing substantially only ETFE or ECTFE.

19. A method of making a wire or cable according to any of the preceding claims, comprising the steps of providing on an electrical conductor the said layers (I) and (II) in contact with each other, and subjecting the said layers while in contact with each other to the said cross-linking reaction.

20. A method according to claim 19, wherein the respective layers are brought into contact with each other (a) prior to cross-linking of either layer and (b) at a temperature above the melting or softening point of the polymeric material in at least one of the layers.

21. A method according to claim 19 or 20, wherein layer (I) is pressure extruded onto the conductor and/or layer (II) is pressure extruded over layer (I).

22. A method according to claim 19, 20, or 21, wherein layers (I) and (II) are co-extruded or tandem extruded onto the wire in a single pass of the conductor from an extrusion process pay-out device to an extrusion process take-up device.
